(19) United States
(12) Patent Application Publication
(10) Pub. No.: US 2020/0338927 A1
(43) Pub. Date: Oct. 29, 2020

(54) Tire Element

(71) Applicant: COMPAGNIE GENERALE DES ETABLISSEMENTS MICHELIN, Clermont-Ferrand (FR)

(72) Inventor: Sylvain MORIVAL, Clermont-Ferrand Cedex 9 (FR)

(21) Appl. No.: 16/955,769

(22) PCT Filed: Dec. 17, 2018
(86) PCT No.: PCT/FR2018/053322

§ 371 Date: Jun. 19, 2020

(30) Foreign Application Priority Data
Dec. 20, 2017 (FR) 17/62577

(51) Int. Cl. B60C 7/12; B60C 7/24

(52) U.S. Cl. CPC B60C 7/12; B60C 2200/12; B60C 7/24

(57) ABSTRACT

A non-pneumatic tire intended to be mounted on a rim and fitted to a lightweight vehicle, and the subject of the present invention is more specifically a tire element, which is able to be wound onto a rim. To increase the load-bearing capability, the tire element (1) has two stiffening portions (6) at least partially not joined together, and each stiffening portion (6) extends in the open main interior cavity (5), from a transition zone between the bead (4) and the sidewall (3) as far as the vicinity of the middle of the crown (2), and delimits, with a portion of tire element (7) facing the said stiffening portion (6), a closed secondary interior cavity (8).

The present invention relates to a non-pneumatic tire intended to be mounted on a rim and fitted to a lightweight vehicle, and the subject of the present invention is more specifically a tire element, which is able to be wound onto a rim in order to constitute a non-pneumatic tire for a lightweight vehicle.

What is meant by a lightweight vehicle is a vehicle that has a low mass, for example a laden weight at most equal to 200 kg, travelling at low speed, for example at most equal to 50 km/h. A bicycle, a baby carriage, a wheelchair for the disabled are examples of lightweight vehicles. Although not limited to this application, the invention will be described more specifically for a non-pneumatic tire intended to be fitted to a lightweight two-wheeled vehicle of the bicycle type.

In the known way, a pneumatic tire is an open hollow toric body made up of at least one elastomer material, subjected to a determined inflation pressure which is dependent on the dimensional characteristics of the tire and on the demands intended to be placed upon it in terms of load and speed, as defined for example by the standards of the European Tire and Rim Technical Organization (the “ETRTO”). A tire usually comprises a tread intended to come into contact with the ground via a tread surface and connected by two sidewalls to two beads intended to collaborate with a rim.

It is also known that a pneumatic tire, inflated to a determined initial pressure, has the disadvantage of seeing a gradual reduction in its pressure over the course of time, hence the need to continuously monitor the pressure and potentially make pressure adjustments. This loss of pressure may be partial, in the event of a loss of sealing at the rim or of the tread being punctured, or may be a total loss of pressure, in the event of the tire bursting.

By definition, a non-pneumatic tire is a toric body made up of at least one polymer material, intended to perform the function of a tire but without being subjected to an inflation pressure. A non-pneumatic tire may be solid or hollow. A hollow non-pneumatic tire may contain air, but at atmospheric pressure, which is to say that it has no pneumatic stiffness afforded by an inflation gas at a pressure higher than atmospheric pressure.

A non-pneumatic tire advantageously makes it possible to eliminate the constraint of monitoring and adjusting the pressure and the risks of a partial or complete loss of pressure of a pneumatic tire.

The rim, on which a non-pneumatic tire is intended to be mounted, comprises two rim flanges connected by a rim base. A rim usually comprises a rim hole allowing the installation of an inflation valve. A rim may be made of a metallic or polymer or composite material.

Various designs of non-pneumatic tire have been proposed in the prior art. Of the non-pneumatic tires proposed, some have been designed to have effective clamping onto the rim. For example, patent application US 20120318421 A1 discloses a non-pneumatic tire made up of a closed hollow body made of elastomer material, fixed to a rim by a clamping element, positioned circumferentially on the inside of the non-pneumatic tire. This clamping element of the cord type comprises two ends, with respectively a locking end and a toothed end, joined together to provide the clamping, at a hole opening to the exterior surface of the non-pneumatic tire. This design has the disadvantage of having a rim-clamping element that can be difficult to insert into the non-pneumatic tire. Furthermore, such a non-pneumatic tire of a given dimension needs to be mounted on a rim of suitable size.

In order to overcome the above disadvantages, document WO 2017067869 proposes a mounted assembly comprising a non-pneumatic tire mounted on a rim, with easier mounting and rim-clamping and with flexible mountability, namely with the possibility of mounting on rims having axial widths that are different but similar, the relative difference being at most equal to 20%. The mounted assembly described in that document comprises a non-pneumatic tire mounted on a rim and a filamentary clamping insert applied to the entire radially interior circumference of the closed toric cavity of the non-pneumatic tire. The clamping insert comprises clamping means applying a preload that ensures clamping by compressing a radially interior portion of the non-pneumatic tire onto the rim. According to the invention, the non-pneumatic tire comprises at least one circumferential through-discontinuity, the radially interior portion of the non-pneumatic tire comprises two deformable beads geometrically fitting the rim under the action of the compressive clamping, and the clamping insert passes successively, radially towards the inside, through the radially interior portion of the non-pneumatic tire and through a hole in the rim, so that the clamping means are positioned radially on the inside of the rim. However, this non-pneumatic tire has the disadvantage of having excessive radial deformation or deflection when mounted on its rim and subjected to a nominal load as defined for example by the ETRTO standard. Excessive radial deflection may in particular lead to blistering, which is to say local detachment, of the central portion of the tread surface in the patch in which the tread surface is in contact with the ground. This blistering leads to impaired operation of the tread, particularly with regards to wear and grip. As a result, the load-bearing capability of such a non-pneumatic tire is not sufficient for optimal operation of the non-pneumatic tire. Furthermore, the non-pneumatic tire described in document WO 2017067869 has the particular feature of being able to be obtained by winding onto a rim a tire element that has been cut to a length substantially equal to the circumference of the rim.

The inventors have set themselves the objective of proposing a tire element, able to be wound onto a rim to constitute a non-pneumatic tire for a lightweight vehicle, such that the non-pneumatic tire thus obtained has an increased load-bearing capability by comparison with a hollow non-pneumatic tire of the prior art.

This objective has been achieved by a tire element, able to be wound onto a rim to constitute a non-pneumatic tire for a lightweight vehicle:

the tire element being a hollow tubular body having a longitudinal midline of length L and comprising at least one polymer material,

the tire element comprising a crown, intended to come into contact with the ground, and connected by two sidewalls to two beads which are intended to collaborate with the rim,

the assembly consisting of the crown, the two sidewalls and the two beads delimiting an open main interior cavity,

the tire element comprising two stiffening portions at least in part not joined together, that is to say partially disjointed with respect to one another, and, in particular, in the open main interior cavity, so as to have mechanical behaviours that are essentially independent

and each stiffening portion extending in the open main interior cavity, from a region of transition between the bead and the sidewall as far as the vicinity of the middle of the crown, and delimiting, with a portion of tire element facing the said stiffening portion, a closed secondary interior cavity, such that the main interior cavity is thus divided into two closed secondary cavities, separated from one another by a third secondary cavity open at the beads.

The subject of the invention is a tire element making it possible to achieve a non-pneumatic tire by winding the said tire element onto a rim. In other words, the non-pneumatic tire is produced directly on the rim by winding the tire element, generally cut to a length substantially equal to the circumference of the mounting rim, and by butting together the end faces of the tire element thus cut. This then is not a toric non-pneumatic tire manufactured beforehand and then mounted on the rim.

The tire element is a hollow tubular body with a longitudinal midline of length L. By definition, the longitudinal midline of the tire element is the locus of the centres of gravity of the sections perpendicular to the said longitudinal midline and is positioned in a longitudinal midplane XZ passing through the middle of the crown. By convention, the direction XX′ is the longitudinal direction, tangential to the longitudinal midline, the direction ZZ′ is the direction perpendicular to the longitudinal midline and positioned in the longitudinal midplane XZ, and the direction YY′ is the transverse direction, perpendicular to the longitudinal midplane XZ.

The tire element comprises at least one polymer material, which is the type of material commonly used in the field of non-pneumatic tires.

The assembly consisting of the crown, the two sidewalls and the two beads delimits an open main interior cavity, this cavity being open at the beads. In other words, the beads are not joined together by a tire element portion. However, this open main interior cavity may contain at least one closed sub-cavity or secondary cavity.

According to a first feature of the invention, the tire element comprises two stiffening portions at least partly not joined together, which make it possible to improve the stiffness of the tire element with respect to compression. These two stiffening portions are partially disjointed with respect to one another and, in particular, in the open main interior cavity, so as to have mechanical behaviours that are essentially independent. They do not therefore, for example, constitute a latticework stiffening structure, and contribute to the stiffness essentially through their intrinsic shape and through the material of which they are made.

According to a second feature of the invention, each stiffening portion extends in the open main interior cavity from each bead as far as the crown and delimits, with a portion of the tire element facing the said stiffening portion, a closed secondary interior cavity. The geometric shape of each stiffening portion therefore provides bracing of the tire element, on either side of its longitudinal midplane. The main interior cavity is thus divided into two closed secondary cavities which are separated from one another by a third secondary cavity open at the beads. Usually, each stiffening portion extends in the open main interior cavity, from a region of transition between the bead and the sidewall, as far as the vicinity of the middle of the crown: this creates bracing between the middle of the crown and the bead, without interaction with the sidewall.

The invention described hereinabove thus makes it possible to increase the load-bearing capability of a non-pneumatic tire, by comparison with a reference hollow non-pneumatic tire without a stiffening portion. The stiffening of the non-pneumatic tire leads to a reduction in the radial deformation of the crown, or deflection, and this makes it possible to ensure full contact between the tread surface and the ground, eliminating any risk of blistering, namely of local detachment of the tread surface in its middle portion.

Preferably, the two stiffening portions are symmetrical with respect to a longitudinal midplane, passing through the middle of the crown and containing the longitudinal midline of the tire element. Because the tire element is itself generally symmetrical with respect to its longitudinal midplane, the symmetry of the stiffening proportions ensures symmetrical behaviour of the non-pneumatic tire as it compresses onto the ground.

Preferably also, with each portion of tire element facing a stiffening portion having, in any transverse plane perpendicular to the longitudinal midline of the tire element, a transverse curvature C₀, each stiffening portion has, in any transverse plane, a transverse curvature C₁ that has the opposite orientation to the transverse curvature C₀ of the portion of tire element facing the stiffening portion. More specifically, because the transverse curvature C₀ of the portion of tire element is concave, the transverse curvature C₁ of the stiffening portion is convex. As a result, upwards of a certain level of compression of the non-pneumatic tire, the two deformed stiffening portions are liable to come into contact with one another and, by bearing against one another via their respective exterior faces, to further increase the stiffness of the non-pneumatic tire with respect to compression.

The tire element is advantageously made of a single polymer material. This is the embodiment that is simplest from the design and manufacture perspective.

In the case of a single polymer material, the polymer material of which the tire element is made preferably has a Shore hardness at least equal to 70. Below that Shore hardness, the stiffening is insufficient. In a known way, the mechanical behaviour of an elastomer compound may be characterized, in particular, by its Shore hardness, measured in accordance with the standards DIN 53505 or ASTM 2240.

According to two particular embodiments of a polymer material that has a Shore hardness at least equal to 70, the polymer material of which the tire element is made is advantageously a thermoplastic elastomer material or a vulcanized thermoplastic material. These types of materials are commonly used in the field of non-pneumatic tires. They have the advantage of having modest curing temperatures, comprised between 120° C. and 250° C.

According to one advantageous embodiment, the tire element has a curved longitudinal midline with a monotonic radius of curvature R. A monotonic radius of curvature R is, in the mathematical sense, a radius that always has the same direction of variation. In other words, such a curved longitudinal midline of a tire element exhibits no inversion of curvature. The benefit of having a monotonic radius of curvature R is that it makes it easier, first of all, to wind the tire element onto a storage spool and then, secondly, that it makes it easier to place it by winding it onto a rim, by virtue of this preformed initial geometry. Specifically, in the case of a rectilinear tire element, which means to say one that has an infinite radius of curvature, during placement of the said element on a rim, the hollow tubular body may be subjected to buckling because of the great extension of its portion corresponding to the crown and because of the great compression of the portion corresponding to the beads. In contrast, in the case of a curved tire element, with a radius of curvature suited to the radius of the rim, the respective deformations of the portions corresponding to the crown and to the beads are limited and are not liable to cause the hollow tubular body to buckle. The radius of curvature R of the tire element is generally substantially constant and needs to be compatible with the radius of the rim to which the tire element is intended to be fitted. For a conventional bicycle, the radius of curvature R may typically be comprised between 200 mm and 500 mm.

According to another advantageous embodiment, each bead comprises a longitudinal groove opening onto an interior face of a bead, facing the open main interior cavity, and extending along the entire length L of the tire element. The presence of such a longitudinal groove in each bead makes it possible in particular to accommodate the ends of a clamping insert there might be, joining the beads together and ensuring better clamping of the non-pneumatic tire onto its rim.

Another subject of the invention is a method for producing a tire element as previously described.

The method for producing a tire element as previously described comprises a step of hot-extruding the hollow tubular body that constitutes the tire element. Such a method makes it possible simultaneously to create the required geometry for the tire element and cure the polymer materials of which the tire element is made. The two steps of extruding and of curing are therefore simultaneous. Typically, given the polymer materials commonly used, such as thermoplastic elastomers or vulcanized thermoplastic, the extrusion temperatures are comprised between 120° C. and 250° C.

Regarding the special case of producing a tire element that has a curved longitudinal mean line having a monotonic radius of curvature R, the method for producing such a tire element comprises a step of hot-extruding the hollow tubular body that constitutes the tire element, using an extrusion nozzle that has a curved longitudinal mean line with a monotonic radius of curvature R. This particular embodiment of the hot-extrusion method makes it possible to obtain directly, by virtue of the curved shape of the extrusion nozzle, a tire element that has a longitudinal mean line that is curved with a monotonic radius of curvature R

The invention is illustrated in the figures referenced hereinbelow, which are not to scale and are described below:

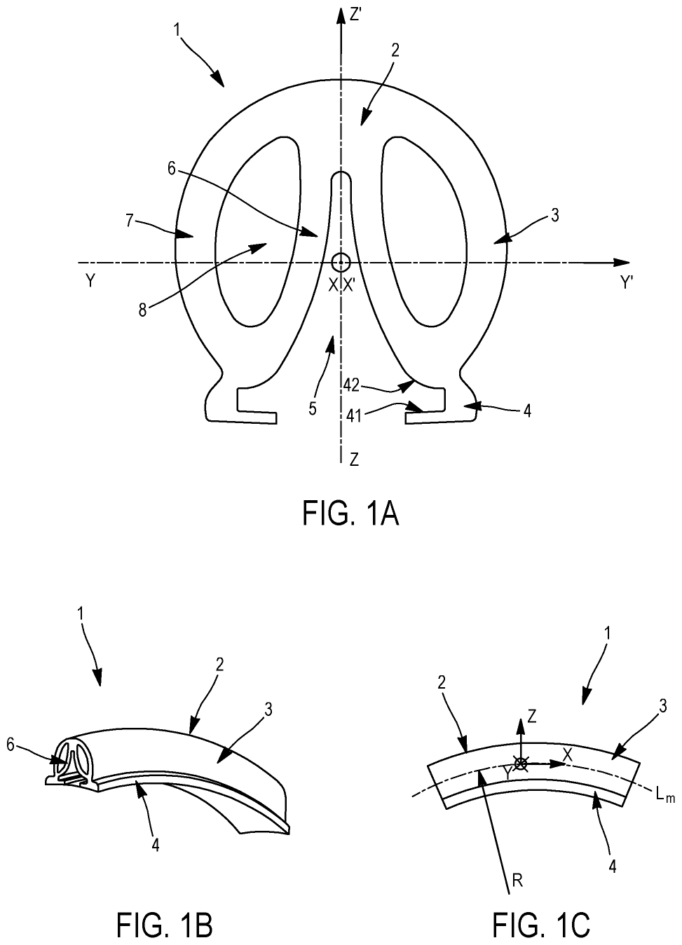

FIG. 1A: Cross section through a tire element according to the invention.

FIG. 1B: Perspective view of a tire element according to the invention.

FIG. 1C: Side view of a tire element according to the invention.

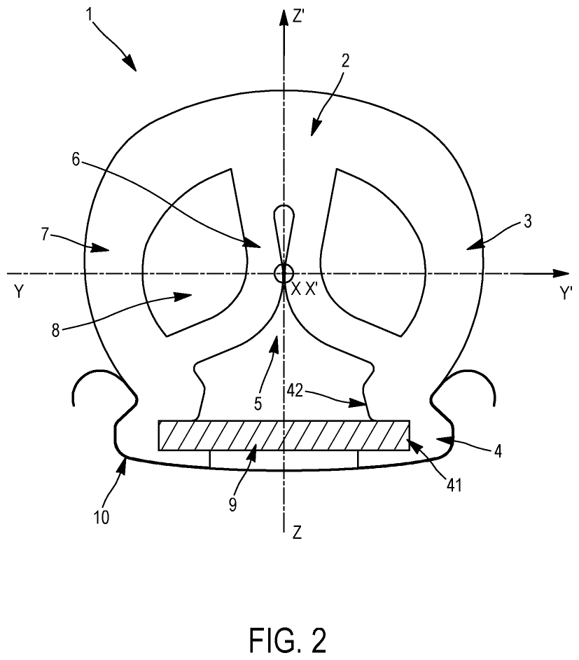

FIG. 2: Cross section through a non-pneumatic tire which is obtained by winding a tire element according to the invention, in a compressed state.

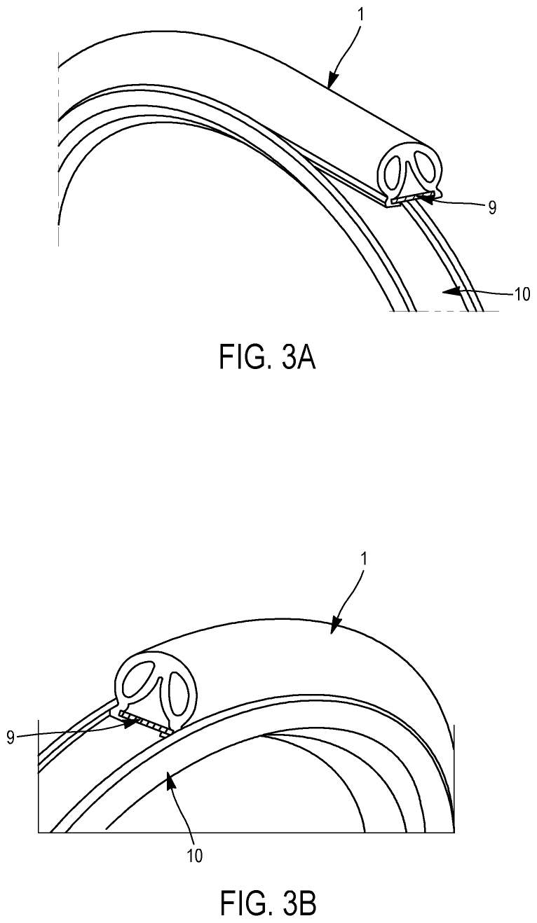

FIG. 3A: Partial perspective view of a non-pneumatic tire in the process of being created, by winding a tire element according to the invention onto a rim.

FIG. 3B: Partial perspective view of a non-pneumatic tire obtained by winding a tire element according to the invention onto a rim.

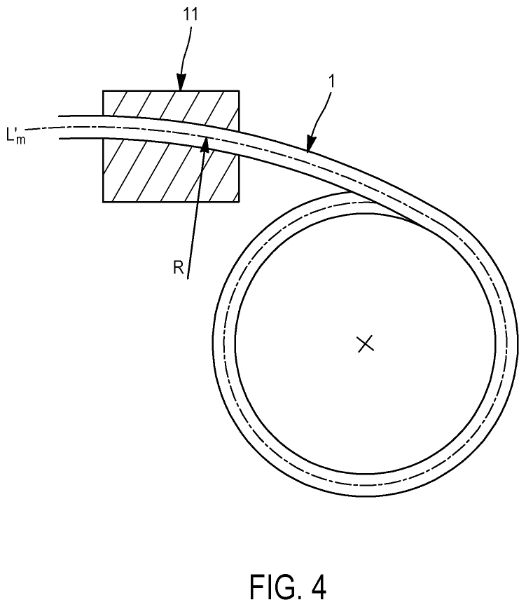

FIG. 4: A schematic diagram of a method for hot-extruding a curved tire element according to a preferred embodiment of the invention.

FIG. 1A depicts a cross section, in a transverse plane YZ, of a tire element according to the invention. The tire element 1 is a hollow tubular body comprising at least one polymer material. It comprises a crown 2, intended to come into contact with the ground, and connected by two sidewalls 3 to two beads 4 which are intended to collaborate with a rim (not depicted). The assembly consisting of the crown 2, the two sidewalls 3 and the two beads 4 delimits an open main interior cavity 5. According to the invention, the tire element 1 comprises two stiffening portions 6 at least partially not joined together, and each stiffening portion 6 extends in the open main interior cavity 5 from each bead 4 as far as the crown 2 and delimits, with a portion of tire element 7 facing the said stiffening portion 6, a closed secondary interior cavity 8. In the preferred embodiment depicted, the two stiffening portions 6 are symmetrical with respect to the longitudinal midplane XZ, passing through the middle of the crown 2 and containing the longitudinal midline Lₘ (depicted in FIG. 1C) of the tire element 1. Furthermore, each stiffening portion 6 has, in the transverse plane YZ, a transverse curvature C₁ that has the opposite orientation to that of the transverse curvature C₀ of the portion of tire element 7 facing the stiffening portion 6. Finally, each bead 4 comprises a longitudinal groove 41 opening onto an interior face 42 of a bead, facing the open main interior cavity 5, and extending along the entire length L of the tire element 1. FIG. 1B is a perspective view of a tire element according to the invention, the cross section of which is depicted in FIG. 1A. Finally, FIG. 1C is a side view of a tire element according to the invention, in the particular instance in which the tire element 1 has a curved longitudinal midline Lₘ having a monotonic radius of curvature R.

FIG. 2 is a cross section, in a transverse plane YZ, of a non-pneumatic tire obtained by winding a tire element according to the invention, in a compressed state. In addition to the elements depicted in FIG. 1A there are a rim 10, on which the tire element is wrapped in order to form a non-pneumatic tire, and a clamping insert 9, the ends of which are positioned in the longitudinal grooves 41 of each bead 4 so as to ensure optimal clamping of the beads 4 to the rim 5. This clamping insert 9, in the case depicted, has the form of a tape extending circumferentially, in the direction XX′, over the entire circumference of the non-pneumatic tire. As the non-pneumatic tire mounted on its rim 10 is compressed onto the ground, the stiffening portions 6 come into contact with one another and, by bearing against one another via their respective exterior faces, increase the stiffness of the non-pneumatic tire with respect to compression.

FIG. 3A is a partial perspective view of a non-pneumatic tire in the process of being created, by winding a tire element according to the invention onto a rim 10. The tire element 1, cut to a length L substantially equal to the circumference of the rim 10 and provided with a clamping insert, in the form of a tape 9, is applied progressively to the rim 10, with the beads being fitted against the rim flanges. FIG. 3B is a partial perspective view of a non-pneumatic tire obtained by winding a tire element according to the invention onto a rim and depicts the final state of the mounting thus achieved.

Finally, FIG. 4 is a schematic diagram of a method for hot-extruding a curved tire element 1, according to a preferred embodiment of the invention. FIG. 4 schematically describes the device for performing the step of hot-extruding the hollow tubular body that constitutes the tire element 1, using an extrusion nozzle 11 that has a curved longitudinal mean line L′ₘ with a monotonic radius of curvature R. The curved tire element 1 obtained therefore has a longitudinal mean line Lₘ that is curved with a monotonic radius of curvature R and is easy to wind onto a storage reel while awaiting the production of a non-pneumatic tire.

The invention has been studied more particularly for the case of a non-pneumatic tire for a bicycle of size 37-622, according to the designation of the ETRTO standard.

Such a non-pneumatic bicycle tire has a section width, in the direction YY′, equal to 37 mm and a section height, in the direction ZZ′, equal to 39 mm. It is intended to be mounted on a rim having a diameter equal to 622 mm Each stiffening portion of the tire element has a thickness equal to 3 mm and a curvilinear length, comprised between its interface with the bead and its interface with the crown, equal to 22 mm. Furthermore, each stiffening portion of the tire element has an interface with the bead which is positioned, in the direction ZZ′, at a distance, from the end of the bead, equal to 3 mm, and has an interface with the crown which is positioned, in the direction YY′, at a distance, with respect to the longitudinal midplane XZ, equal to 2 mm. The polymer material of which the tire element is made is a vulcanized thermoplastic material having a Shore A hardness equal to 86, measured at 23° C., and a cure temperature of between 175° C. and 230° C. Finally, the tire element has a curved longitudinal midline having a monotonic radius of curvature R equal to approximately 300 mm.

The inventors have demonstrated that the stiffening of the non-pneumatic tire leads to a significant reduction in the radial deformation of the crown, or deflection. The deflection changes from 15 mm, for a reference non-pneumatic tire without a stiffening portion, to a deflection of 5 mm for a non-pneumatic tire according to the invention, with two stiffening portions, which is to say that the deflection is reduced by a factor of 3, for the same applied load.

1. A tire element, able to be wound onto a rim to constitute a non-pneumatic tire for a lightweight vehicle, the tire element comprising:
tire a hollow tubular body having a longitudinal midline (Lₘ) of length L and comprising at least one polymer material,
tire a crown, intended to come into contact with the ground, and connected by two sidewalls to two beads which are intended to collaborate with the rim,
the assembly consisting of the crown, the two sidewalls and the two beads delimiting an open main interior cavity,
wherein the tire element further comprises two stiffening portions at least partially disjointed with respect to one another in the open main interior cavity, so as to have mechanical behaviours that are essentially independent, wherein each stiffening portion extends in the open main interior cavity, from a transition zone between the bead and the sidewall as far as the vicinity of the middle of the crown, and delimits, with a portion of tire element facing the said stiffening portion, a closed secondary interior cavity, such that the main interior cavity is divided into two closed secondary cavities, separated from one another by a third secondary cavity open at the beads.

2. The tire element according to claim 1, wherein the two stiffening portions are symmetrical with respect to a longitudinal midplane (XZ), passing through the middle of the crown and containing the longitudinal midline (Lₘ) of the tire element.

3. The tire element according to claim 1, wherein each portion of the tire element facing a stiffening portion having, in any transverse plane (YZ) perpendicular to the longitudinal midline (Lₘ) of the tire element, a transverse curvature C₀, wherein each stiffening portion has, in any transverse plane (YZ), a transverse curvature C₁ that has the opposite orientation to the transverse curvature C₀ of the portion of tire element facing the stiffening portion (6).

4. The tire element according to claim 1, wherein the tire element is made of a single polymer material.

5. The tire element according to claim 4, wherein the polymer material of which the tire element is made has a Shore hardness at least equal to 70.

6. The tire element according to claim 5, wherein the polymer material of which the tire element is made is a thermoplastic elastomer material or a vulcanized thermoplastic material.

7. The tire element according to claim 1, wherein the tire element has a curved longitudinal midline (Lₘ) having a monotonic radius of curvature R.

8. The tire element according to claim 1, wherein each bead comprises a longitudinal groove opening onto an interior face of a bead, facing the open main interior cavity, and extending along the entire length L of the tire element.

9. A method for producing a tire element according to claim 1, comprising a step of hot-extruding the hollow tubular body that constitutes the tire element.

10. The method according to claim 9 tire, comprising a step of hot-extruding the hollow tubular body that constitutes the tire element, using an extrusion nozzle that has a curved longitudinal mean line (L′ₘ) with a monotonic radius of curvature R.

11. A method for producing a tire element according to claim 7, comprising a step of hot-extruding the hollow tubular body that constitutes the tire element.
